(19) United States
(12) Patent Application Publication
(10) Pub. No.: US 2012/0213338 A1
(43) Pub. Date: Aug. 23, 2012

(54) C-ARM X-RAY MACHINE WITH COUNTERBALANCE

(76) Inventors: Reinhold Hartwich, Pleystein (DE); Norbert Herrmann, Ebnath (DE); Andreas Limmer, Seybothenreuth (DE)

(21) Appl. No.: 13/396,969

(22) Filed: Feb. 15, 2012

(30) Foreign Application Priority Data
Feb. 16, 2011 (DE) DE 102011004228.8

(51) Int. Cl. H05G 1/02

(52) U.S. Cl. 378/197

(57) ABSTRACT

A C-arm X-ray machine includes a C-arm that is rotatable about an orbital axis running perpendicular to a C-arm plane. The C-arm includes an X-ray source and an X-ray detector. An overall center of gravity of the C-arm, the X-ray source, and the X-ray detector exerts a first torque on the C-arm. A mass motionally coupled to the C-arm via a rotatable contour disk produces a second torque compensating the first torque.

This application claims the benefit of DE 10 2011 004 228.8, filed on Feb. 16, 2011.

### BACKGROUND

The present embodiments relate to a C-arm X-ray machine.

C-arm units are widely used in medical engineering. In such applications, a diagnostic or treatment apparatus is attached to a C-shaped basic body. Because of the shape, the C-arm and the diagnostic or treatment apparatus may be rotated around a region of interest of a patient for examination or treatment purposes, thereby achieving different angular positions between the patient and the diagnostic or treatment apparatus without the patient having to be repositioned.

Widely used as diagnostic apparatus, for example, are X-ray devices, in which an X-ray source is mounted at one end of the C-arm and an X-ray receiver or image intensifier at the opposite end. An X-ray C-arm of this kind has a considerable weight.

If, in the case of a C-arm, a radiation isocenter coincides with a center of the C-arm, the C-arm is termed an isocentric C-arm. X-ray C-arms of this design, in which a central ray of the X-ray system beam passes through the isocenter of the arrangement lying on the orbital axis (e.g., axis of rotation of the orbital movement), the weight ratios are such that the overall center of gravity of the arrangement is outside the isocenter (e.g., spaced radially away from the orbital axis). The self-weight of the arrangement therefore exerts a torque on the C-arm. The center of gravity of the arrangement tends to a stable equilibrium position (e.g., to the lowest point below the orbital axis that may be achieved by the orbital movement).

To retain the C-arm in a particular position or during movement, force is therefore applied against the intrinsic angular momentum of the arrangement. For example, the C-arm is to be fixed in a particular position by a suitable braking device on the support device.

It is desirable to create a counterbalance on the C-arm so that the C-arm is virtually force-free in every movement position (e.g., no torque with respect to the axis of rotation is exerted on the C-arm). There are several solutions for a counterbalance that are described in DE 10 2004 011 460 A1.

A first solution is to place the X-ray source and the image intensifier such that the overall center of gravity of the C-arm and the X-ray device lies on the axis of rotation. Because of the weight of the X-ray components, the X-ray components are moved nearer to ends of the C-arm to counterbalance the weight of the C-arm. As a result, the central ray of the X-ray system beam no longer passes through the isocenter of the arrangement.

In a second solution, the X-ray system is placed such that a central ray of a beam passes through the isocenter. In addition, extra weights are mounted on the ends of the C-arm in order to shift the overall center of gravity of the arrangement to the isocenter. However, the heavy additional weights significantly increase the total weight of the arrangement and subject the C-arm to mechanical stress, causing the C-arm to self-deform.

A third solution is to act on the C-arm with brakes and an electric motor drive such that the torque produced by the center of gravity of the C-arm by gravitational force is compensated by the electric drive and the brakes. However, the disadvantage of this solution is that the C-arm requires electric power to move the C-arm. In the event of a power failure, this may cause a hazardous situation for the patient, as no access space to the patient may be created by moving the C-arm.

In a fourth solution, a C-arm counterbalancing device contains a counterweight motionally coupled to the C-arm via a transmission.

Patent specification DE 691 19 904 T2 discloses a C-shaped X-ray examination apparatus with a counterbalance that operates using a counterweight.

### SUMMARY AND DESCRIPTION

The present embodiments may obviate one or more of the drawbacks or limitations in the related art. For example, a C-arm X-ray machine with counterbalance is provided.

In one embodiment, a C-arm X-ray machine includes a C-arm that is rotatable about an orbital axis running perpendicular to a plane of the C-arm. The C-arm X-ray machine includes an X-ray source and an X-ray detector. An overall center of gravity of C-arm, the X-ray source and the X-ray detector exerts a first torque on the C-arm. A mass motionally connected to the C-arm via a rotatable contour disk generates a second torque that compensates the first torque by the weight of the mass. With respect to an orbital movement, the C-arm advantageously is completely weight-compensated and remains torque-free in every rotational position.

In one embodiment, rotation of the C-arm about the orbital axis may co-rotate the contour disk such that the second torque compensates the first torque.

In another embodiment, a change in an angle of the C-arm may cause a change in an angle of the contour disk.

In addition, rotation of the contour disk may alter a counterweight lever arm that produces the second torque.

In another embodiment, the C-arm X-ray machine may include a belt drive connected to the C-arm. The belt drive converts the rotation of the C-arm into rotation of the contour disk.

In yet another embodiment, the contour disk may have a contour such that the lever arm producing the second torque follows a cosine function during rotation of the contour disk.

In one embodiment, the C-arm may be pivoted about the axis of angulation intersecting the orbital axis at right angles.

In another embodiment, the C-arm may be movably mounted on a support device incorporating the contour disk and a housing.

### BRIEF DESCRIPTION OF THE DRAWINGS

FIG. 1 schematically illustrates parts of one embodiment of a C-arm X-ray machine.

### DETAILED DESCRIPTION OF THE DRAWINGS

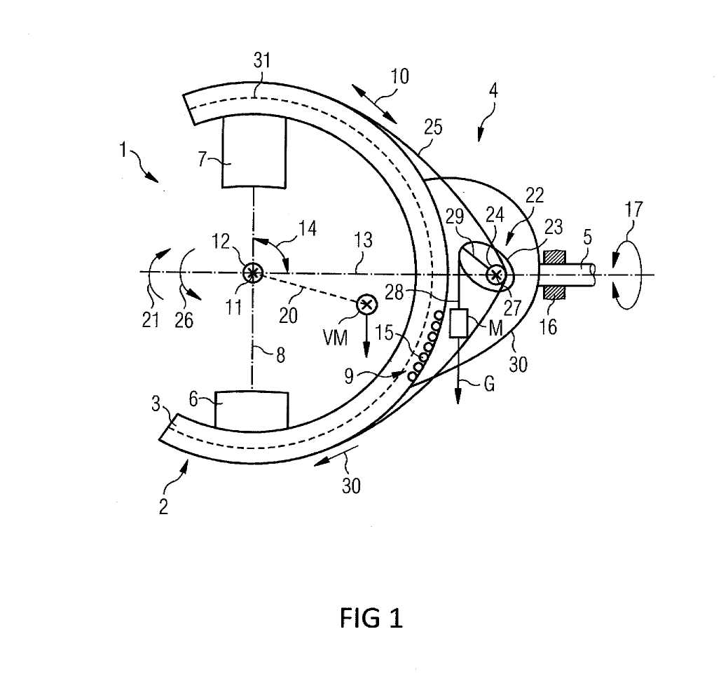

FIG. 1 illustrates parts of one embodiment of a C-arm X-ray machine 1. Only a C-arm 3 carrying an X-ray system 2 and a support device 4 for the C-arm 3 are shown. Not shown is a stand of the C-arm apparatus 1 supporting the entire arrangement on a bearing shaft 5. The X-ray system 2 includes an X-ray source 6 and an X-ray receiver 7 (e.g., an image intensifier 7). A central ray 8 of an X-ray cone beam (not shown) emitted by the X-ray source 6 exits the X-ray source 6 centrally and is incident on a center of the image intensifier 7.

The C-arm 3 is mounted in an orbitally movable manner on a roller bearing 9 fixed to the support device 4. A direction of travel of the C-arm 3 on the support device 4 is indicated by the double-headed arrow 10. In a movement of this kind, the C-arm 3 and the X-ray system 2 describe orbital movements about an orbital axis 11 passing perpendicularly through the plane of the drawing in FIG. 1. The orbital axis 11 and the central ray 8 intersect at an isocenter 12. In FIG. 1, the C-arm 3 is in a 90° position (e.g., the central ray 8 includes an angle 14 of 90° with a horizontally running axis of angulation 13 centrally continuing a bearing shaft 5). When traveling in the direction 10, the C-arm 3 slides over rollers 15 of the roller bearing 9 on a circular-path-shaped running surface 31 provided on the C-arm 3.

In addition to the orbital movement of the C-arm 3 with respect to the support device 4, the C-arm 3, the support device 4, and the bearing shaft 5 may be pivoted in a direction of the double-headed arrow 17 about the axis of angulation 13 in a shaft bearing 16 belonging to a stand (not shown) of the C-arm apparatus 1. In each orbital and angular pivoting position of the C-arm apparatus 1, the orbital axis 11 and the central ray 8 intersect at right angles and pass through the isocenter 12, which is fixed as long as the stand of the C-arm apparatus 1 is fixed.

At an overall center of gravity 18, a total mass of the C-arm 3 and the X-ray system 2 is shown as a virtual total mass VM. The force of gravity 19 acting on the total mass VM exerts a first torque 21 with respect to the orbital axis 11 on the C-arm 3 via a lever arm 20 extending from the isocenter 12 to the overall center of gravity 18. An effective lever arm length results from a projection of the virtual lever arm 20 onto the horizontally disposed axis of angulation 13. If the C-arm 3 is orbitally pivoted from the position shown in FIG. 1, the first torque 21 varies in a cosinally shaped manner with the corresponding rotation angle 14, as the effective length of the virtual lever arm 20 changes.

The support device 4 contains a compensating device 22. The compensating device 22 includes a contour disk 23 mounted eccentrically about an axis of rotation 27. A belt pulley 24 is connected to the contour disk 23 with rigidly the same axis of rotation 27. The belt pulley 24 is driven by a belt 25 that is permanently connected to an outside of the C-arm 3. As a result, an orbital rotation 10 of the C-arm 3 produces a rotation of the contour disk 23 in the same rotational direction. On a side of the contour disk 23 facing the C-arm 3, a mass M of weight G is suspended by a cable 28. This suspension together with a lever arm 29 that changes due to rotation of the contour disk 23 produces, about the axis of rotation 27, a torque that is converted via the belt pulley 24 and the belt 25 into a second torque 26 that acts on the C-arm 3. An effective length of the lever arm 29 that determines the second torque 26 results from the projection of the lever arm 29 onto the horizontal.

The second torque 26 changes depending on a position of the contour disk 23. A shape of the contour disk 23, the mass M, and a radius of the belt pulley 24 are selected such that, in each orbital rotational position of the C-arm 3, the first torque 21 and the second torque 26 cancel each other out. With respect to the orbital movement 10, the C-arm 3 is therefore completely weight-compensated and remains torque-free in each rotational position.

Without a counterforce being applied (e.g., without the second torque 26), the force of gravity may cause the C-arm 3 to slide down in the support device 4 in the direction of the arrow 30 until the overall center of gravity 18 finds a stable position of equilibrium in the gravitational direction below the isocenter 11.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A C-arm X-ray machine comprising:
a C-arm that is rotatable about an orbital axis running perpendicular to a plane of the C-arm, the C-arm comprising an X-ray source and an X-ray detector, wherein an overall center of gravity of the C-arm, the X-ray source, and the X-ray detector exerts a first torque on the C-arm;
an eccentrically mounted rotatable contour disk that is motionally coupled to the C-arm; and
a mass suspended from the contour disk such that, by rotation of the contour disk, the weight of the mass produces a second torque compensating the first torque.

2. The C-arm X-ray machine as claimed in claim 1, wherein rotation of the C-arm about the orbital axis co-rotates the contour disk such that the second torque balances the first torque.

3. The C-arm X-ray machine as claimed in claim 1, wherein a first change of angle brings about a second change, the first change of angle being of the C-arm, the second change of angle being of the contour disk.

4. The C-arm X-ray machine as claimed in claim 1, wherein rotation of the contour disk changes a lever arm of the mass producing the second torque.

5. The C-arm X-ray machine as claimed in claim 1, further comprising a belt drive connected to the C-arm, the belt drive being operable to convert rotation of the C-arm into the rotation of the contour disk.

6. The C-arm X-ray machine as claimed in claim 4, wherein the contour disk has a contour such that the lever arm producing the second torque follows a cosine function during the rotation of the contour disk.

7. The C-arm X-ray machine as claimed in claim 1, wherein the C-arm is pivotable about an axis of angulation intersecting the orbital axis at right angles.

8. The C-arm X-ray machine as claimed in claim 1, wherein the C-arm is movably mounted on a support device incorporating the contour disk and a housing.

9. The C-arm X-ray machine as claimed in claim 2, wherein a first change of angle brings about a second change, the first change of angle being of the C-arm, the second change of angle being of the contour disk.

10. The C-arm X-ray machine as claimed in claim 2, wherein rotation of the contour disk changes a lever arm of the mass producing the second torque.

11. The C-arm X-ray machine as claimed in claim 3, wherein rotation of the contour disk changes a lever arm of the mass producing the second torque.

12. The C-arm X-ray machine as claimed in claim 2, further comprising a belt drive connected to the C-arm, the belt drive being operable to convert rotation of the C-arm into the rotation of the contour disk.

13. The C-arm X-ray machine as claimed in claim 3, further comprising a belt drive connected to the C-arm, the belt drive being operable to convert rotation of the C-arm into the rotation of the contour disk.

14. The C-arm X-ray machine as claimed in claim 4, further comprising a belt drive connected to the C-arm, the belt drive being operable to convert rotation of the C-arm into the rotation of the contour disk.

15. The C-arm X-ray machine as claimed in claim 14, wherein the contour disk has a contour such that the lever arm producing the second torque follows a cosine function during the rotation of the contour disk.

16. The C-arm X-ray machine as claimed in claim 2, wherein the C-arm is pivotable about an axis of angulation intersecting the orbital axis at right angles.

17. The C-arm X-ray machine as claimed in claim 3, wherein the C-arm is pivotable about an axis of angulation intersecting the orbital axis at right angles.

18. The C-arm X-ray machine as claimed in claim 4, wherein the C-arm is pivotable about an axis of angulation intersecting the orbital axis at right angles.

19. The C-arm X-ray machine as claimed in claim 2, wherein the C-arm is movably mounted on a support device incorporating the contour disk and a housing.

20. The C-arm X-ray machine as claimed in claim 3, wherein the C-arm is movably mounted on a support device incorporating the contour disk and a housing.
